(19) United States
(12) Patent Application Publication
(10) Pub. No.: US 2013/0087664 A1
(43) Pub. Date: Apr. 11, 2013

(54) DISPOSABLE UTENSIL REST

(71) Applicant: MICHAEL SHAWN WEAVEL, Bonita Springs, FL (US)

(72) Inventor: MICHAEL SHAWN WEAVEL, Bonita Springs, FL (US)

(21) Appl. No.: 13/270,562

(22) Filed: Oct. 11, 2011

(51) Int. Cl. A47G 29/00; G09F 3/00; B31F 5/02

(52) U.S. Cl. 248/37.3; 493/356; 40/299.01

(57) ABSTRACT

A disposable utensil rest that helps keeps eating utensils from direct contact with a table or counter top. The disposable utensil rest includes a unitary piece blank, at least one folding line pre-form on the unitary piece blank, a plurality of cutting lines pre-cut on the unitary piece blank, the folding lines and the cutting lines forming a pattern. The utensil rest is shaped by cutting the unitary piece blank by following the cutting lines and folding the unitary piece blank by following the folding lines, and the utensil rest is disposable.

### BACKGROUND OF THE INVENTION

The present invention generally relates to a rest for eating utensils.

More particularly, the present invention relates to a disposable rest for supporting eating utensils in a dining setting.

In view of the increase of diseases caused by bacteria in recent years, people are concerned with table hygiene in public and private places. Utensil rests are often used on many dinner tables to provide a raised surface for the eating utensil to prevent the eating utensil from touching the table. Unfortunately, because of manufacturing cost, these utensil rests are often reused and if proper care is not taken, the utensils can become contaminated.

As can be seen, there is a need for a disposable utensil rest that is economical and easy to manufacture.

### SUMMARY OF THE INVENTION

In one aspect of the present invention, a disposable utensil rest includes a unitary piece blank, at least one folding line pre-form on the unitary piece blank, a plurality of cutting lines pre-cut on the unitary piece blank, the folding lines and the cutting lines form a pattern, the utensil rest is shaped by cutting the unitary piece blank by following the cutting lines and folding the unitary piece blank and by following the folding lines, the utensil rest is disposable.

In another aspect of the present invention, a method for forming a utensil rest comprises the steps of forming a blank, pre-forming at least one folding line on the blank, pre-cutting a plurality of cut cutting lines on the blank, cutting the blank by following the cutting lines, folding the blank by following the folding lines, and shaping the utensil rest by following the folding lines, the utensil rest is disposable.

These and other features, aspects and advantages of the present invention will become better understood with reference to the following drawings, description and claims.

### BRIEF DESCRIPTION OF THE DRAWINGS

FIG. 1 illustrates a perspective front view of an utensil rest according to an exemplary embodiment of the present invention showing the utensil rest in use;

FIG. 2 illustrates a side view of the utensil rest of FIG. 1;

FIG. 3 illustrates a front view of a blank use to manufacture the utensil rest of FIG. 1;

FIG. 4 illustrates a perspective front view of a utensil rest according to a second exemplary embodiment of the present invention showing a utensil rest for multiple utensils;

FIG. 5 illustrates a perspective front view of the utensil rest of FIG. 1 showing the utensil rest with a packing container;

FIG. 6 illustrates front view of a blank used to manufacture the utensil rest according to a third exemplary embodiment of the present invention;

FIG. 7 illustrates a perspective front view of the utensil rest of FIG. 6;

FIG. 8 illustrates front view of a blank used to manufacture the utensil rest according to a fourth exemplary embodiment of the present invention;

FIG. 9 illustrates a perspective front view of the utensil rest of FIG. 8;

FIG. 10 illustrates front view of a blank used to manufacture the utensil rest according to a fifth exemplary embodiment of the present invention; and

FIG. 11 illustrates a perspective front view of the utensil rest of FIG. 10.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a disposable utensil rest that helps keeping eating utensils from direct contact with a table or counter top.

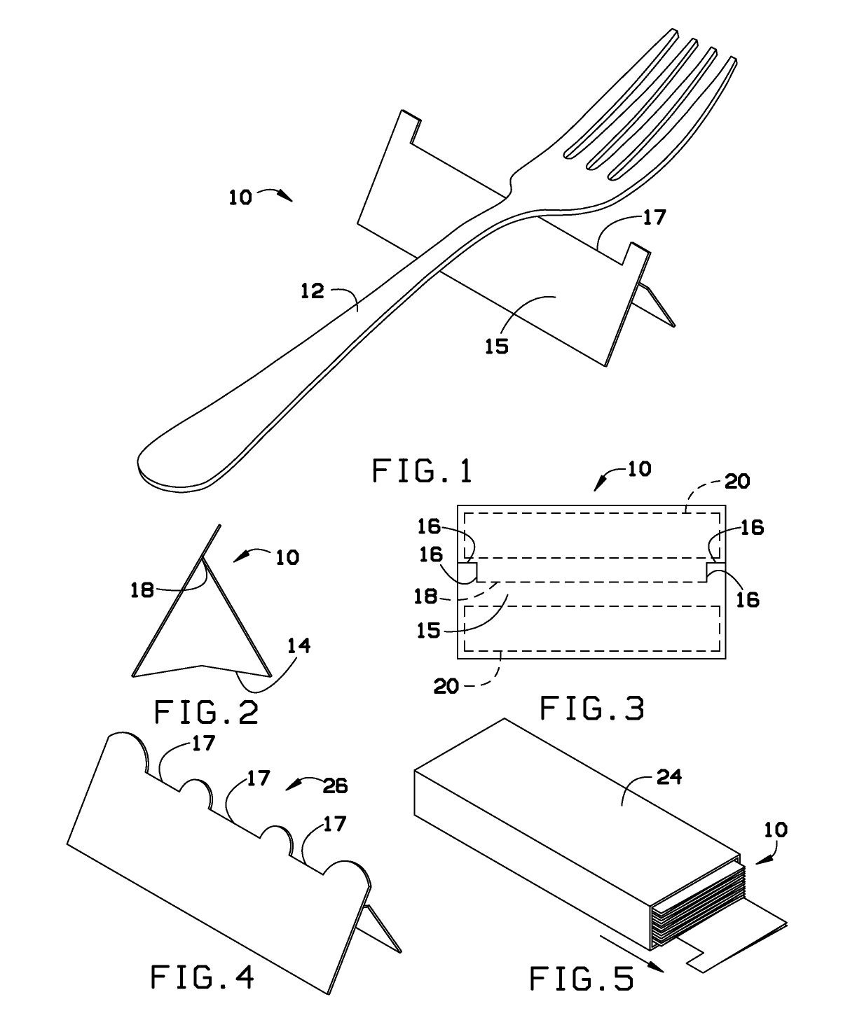

FIGS. 1-3 show a utensil rest 10 according to an exemplary embodiment of the present invention. The utensil rest 10 may keep an eating utensil 12 from touching a surface (not shown) such as dining tables or counter tops. The utensil rest 10 may be a disposable utensil rest.

The utensil rest 10 may include a unitary piece blank 15 made of a sturdy and flexible material. The unitary piece blank 15 may be of, for example, plastic, paperboard, or cardboard. The unitary piece blank may be made, for example, by molding, injection molding, or machining. The size and shape of the unitary piece blank 15 may depend on the user's requirements. The unitary piece blank 15 may have a geometrical shape for example a rectangle, a square, a circle, or a triangle.

A support element 14 may be secured to the ends of the unitary piece body in order to keep the mechanical structure of the utensil rest 10. The support element 14 may prevent the unitary piece body from going from a folded working position to an unfolded non working position. The support element 14 may be a strip of, for example, a strong adhesive tape, plastic, paperboard, or cardboard.

FIG. 3 shows that folding lines 18 may be pre-formed into the unitary piece blank 15. The folding lines 18 may be use as a guide to fold the unitary piece blank when assembling the utensil rest 10 to a working position. The folding line 18 may run from a first end of the unitary piece blank 15 to a second end of the unitary piece blank 15. The folding line 18 may run, for example, at a middle area of the unitary piece blank 15.

Cutting lines 16 may be pre-cut on the unitary piece blank 15. The cutting lines 16 may be used as a guide to cut the unitary piece blank 15 in order to form cutouts 17 on the utensil rest 10. The cutouts 17 may be used to rest the eating utensil 12. The shape and number of cutouts 17 may depend on the user's preferences.

The unitary piece blank 15 may include a printing area 20. The printing area 20 may be used to print for example advertising materials, holiday motives, decorations, art, poems, and logos.

As can be seen from FIG. 5, several utensil rests 10 may be placed in a packing container 24. The packing container 24 may be a commercially available packing container, for example, boxes, pouches, or bags.

As can be seen from FIGS. 4, and 6-11, the utensil rest 10 may have different embodiments, which may depend on a pattern formed by the cutting lines 16 and the folding lines 18.

FIG. 4 shows a utensil rest 26 according to a second exemplary embodiment of the present invention. The utensil rest 26 may include a plurality of cutouts 17 in order to rest multiple eating utensils 12.

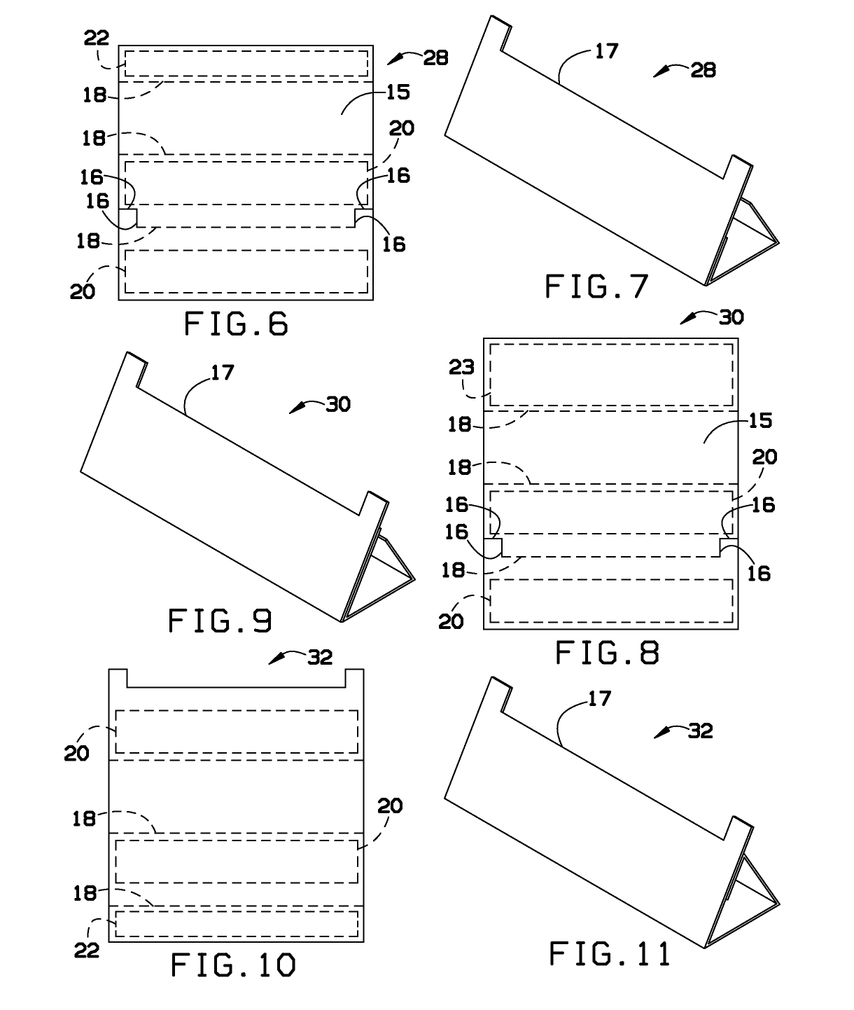

FIGS. 6-7 show a utensil rest 28 and a unitary piece blank 15 according to a third exemplary embodiment of the present invention. FIG. 6 shows that the unitary piece blank 15 may include a strip of adhesive tape 22 placed at one end and a plurality of folding lines 18 located through the blank 15. FIG. 7 shows that after folding the unitary piece blank 15 at each one of the folding lines 18, the assembled utensil rest 28 may have a triangular shape. In the working position, the strip of adhesive tape 22 may be secured to a section of the unitary piece blank 15 near the one of the folding lines 18.

FIGS. 8-9 show an utensil rest 30 and unitary piece blank 15 according to a fourth exemplary embodiment of the present invention. FIG. 9 shows that the unitary piece blank 15 may include an adhesive area 23 placed at one end and a plurality of folding lines 18 located through the unitary piece blank 15. FIG. 8 shows that after folding the unitary piece blank 15 at each one of the folding lines 18, the assembled utensil rest 30 may have a triangular shape. The adhesive area 23 may be secured to an opposite end of the unitary piece blank 15.

FIGS. 10-11 show a utensil rest 32 and the unitary piece blank 15 according to a fifth exemplary embodiment of the present invention. FIG. 10 shows that the unitary piece blank 15 may include a strip of adhesive tape 22 placed at one end and a plurality of folding lines 18 located through the unitary piece blank 15. FIG. 11 shows that after folding the unitary piece blank 15 at each one of the folding lines 18, the assembled utensil rest 32 may have a triangular shape. The strip of adhesive tape 22 may be secured to a section of the unitary piece blank 15 near the cutout 17.

The user (not shown) may cut the unitary piece blank 15 as indicated by the cutout lines 16. Then, the user may fold the blank 15 as indicated by the folding lines 18. If required, the user may secure the adhesive area or strip of adhesive material to the opposite end of the blank. If required, the user may secure the opposite ends of the unitary piece blank 15 with the support element 14, the strip of adhesive tape 22, or the adhesive area 23.

The utensil rest 10, 26, 28, 30, 32 may be used to support any eating utensil for example, spoons, knives, forks, chopsticks, serving utensils.

It should be understood, of course, that the foregoing relates to exemplary embodiments of the invention and that modifications may be made without departing from the spirit and scope of the invention as set forth in the following claims.

What is claimed is:

1. A utensil rest comprising:
a unitary piece blank having a first end and a second end;
at least one folding line pre-formed on the unitary piece blank;
a plurality of cutting lines pre-cut on the unitary piece blank; and
wherein the folding lines and the cutting lines form a pattern;
wherein the utensil rest is shaped by cutting the unitary piece blank by following the cutting lines and folding the unitary piece blank by following the folding lines;
wherein the utensil rest is disposable.

2. The utensil rest according to claim 1, wherein the blank is made of plastic.

3. The utensil rest according to claim 1, wherein the blank is made by molding, injection molding, or machining.

4. The utensil rest according to claim 1, further including a support element secured to the first end and the second end of the unitary piece blank when the utensil rest is in a working position.

5. The utensil rest according to claim 1, further including at least one printing area near the first end and near the second end of the blank.

6. The utensil rest according to claim 5, wherein the printing area includes advertising materials, holiday motives, decorations, art, poems, or logos.

7. The utensil rest according to claim 1, further including a strip of adhesive tape placed on the first end of the unitary piece blank.

8. A method for forming a utensil rest comprising the steps of:
forming a unitary piece blank having a first end and a second end, wherein the blank is made of a sturdy material;
pre-forming at least one folding line on the blank;
pre-cutting a plurality of cutting lines on the blank;
cutting the blank by following the cutting lines;
folding the blank by following the folding lines; and
shaping the utensil rest by following the folding lines, wherein the utensil rest is disposable.

9. The method according to claim 8, wherein the unitary piece blank is made of plastic.
